(19) United States
(12) Patent Application Publication
(10) Pub. No.: US 2017/0144943 A1
(43) Pub. Date: May 25, 2017

(54) WOOL PELLETS FOR PLANT FERTILIZATION AND RELATED METHODS

(71) Applicants: Brian D. Gold, West Haven, UT (US); Albert R. Wilde, Croydon, UT (US)

(72) Inventors: Brian D. Gold, West Haven, UT (US); Albert R. Wilde, Croydon, UT (US)

(21) Appl. No.: 14/952,475

(22) Filed: Nov. 25, 2015

(51) Int. Cl. C05F 1/00; C05G 3/00; C05B 17/00; C05C 11/00; C05D 1/00

(52) U.S. Cl. CPC C05F 1/005; C05C 11/00; C05D 1/00; C05B 17/00; C05G 3/0058

(57) ABSTRACT

A pellet for fertilizing and watering plants may include wool from a belly area of one or more sheep compressed in a pelletized form. The wool may also include natural lanolin. Methods for making pellets may include selecting and obtaining a type and cut of wool from an animal, not removing natural lanolin from the wool, and pelletizing the wool. Methods for providing a substance to roots of plants may include distributing pellets throughout a soil composition, adding water to the pellets and soil composition, and allowing the pellets to release the substance to the soil composition and roots of the plants.

### TECHNICAL FIELD

This disclosure relates generally to pellets including animal wool and to using pellets including animal wool to provide nutrients and water to plants.

### BACKGROUND

To qualify as organic, foods have to be grown while following strict guidelines provided by the United States Department of Agriculture (“USDA”). The recent push by consumers for more naturally grown or organic food has caused farmers to change fertilization and watering methods in an effort to provide food that qualifies as organic. However, fertilizers that can be used in organic growing are very limited, and in most cases, do not forecast a consistent growing result. With the lack of fertilizers, organic crops are often smaller, less healthy, and less profitable. Additionally, farmers cannot reliably plan on a quantity or quality of crop. Furthermore, organic crops are more costly to care for as conventional pesticides are not permitted in organic growing.

### BRIEF SUMMARY

Some embodiments of the present disclosure include a pellet for fertilizing and watering plants. The pellet may include wool from a belly area of one or more sheep compressed in a pelletized form. The wool may include natural lanolin.

Some embodiments of the present disclosure include a method of making pellets for fertilizing and watering plants. The method may include selecting and obtaining a type and cut of wool from an animal, not removing natural lanolin from the wool, and pelletizing the wool.

Some embodiments of the present disclosure include a method of providing a substance to roots of a plant. The method may include distributing pellets throughout a soil composition, adding water to the pellets and soil composition, and allowing the pellets to release the substance to the soil composition and roots of the plant. The pellets may include wool from a belly area of a sheep and a binding agent. The wool may include natural lanolin.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a perspective view of a fertilizing and watering pellet according to an embodiment of the present disclosure;

FIG. 2 is a cross-sectional view of a soil composition containing the pellets of FIG. 1;

FIG. 3 shows a flowchart of a method of making fertilizing and watering pellets according to an embodiment of the present disclosure;

FIG. 4 shows a flowchart of a method of providing nutrients to plants with fertilizing and watering pellets according to an embodiment of the present disclosure; and

FIG. 5 shows a flowchart of a method of providing water to plants with fertilizing and watering pellets according to an embodiment of the present disclosure.

### DETAILED DESCRIPTION

The illustrations presented herein are not actual views of any particular electronic circuit, trace, energetic substrate, or any component, but are merely idealized representations, which are employed to describe the present invention.

As used herein, any relational term, such as “first,” “second,” “top,” “bottom,” “beneath,” etc., is used for clarity and convenience in understanding the disclosure and accompanying drawings, and does not connote or depend on any specific preference or order, except where the context clearly indicates otherwise.

Some embodiments of the present disclosure include pellets for fertilizing and providing water to plants. The pellets may be formed from sheep wool and, in some embodiments, a binding agent. In some embodiments, the pellets may be considered organic. As used herein, the term “organic” and any derivative terms means that the methods or products (e.g., pellets) qualify for designation as “Certified Organic,” as defined under the United States Department of Agriculture organic regulations as of Nov. 16, 2015 (hereinafter “USDA organic regulations”).

Some embodiments of the present disclosure include methods of providing nutrients to (e.g., fertilizing) plants using pellets. For example, the pellets may be distributed throughout a soil composition in which a plant is growing. The wool of the pellets may begin to decompose and provide nutrients, such as, for example, nitrogen, to the plant growing in the soil composition. In some embodiments, plants grown with the methods for providing nutrients to plants may qualify as organic as defined above.

Some embodiments of the present disclosure include methods of providing water to plants using pellets. For example, the pellets may be distributed throughout a soil composition in which a plant in growing. Water may be added to the soil composition, the pellets may absorb the water, and the pellets may release the water to the soil composition over time.

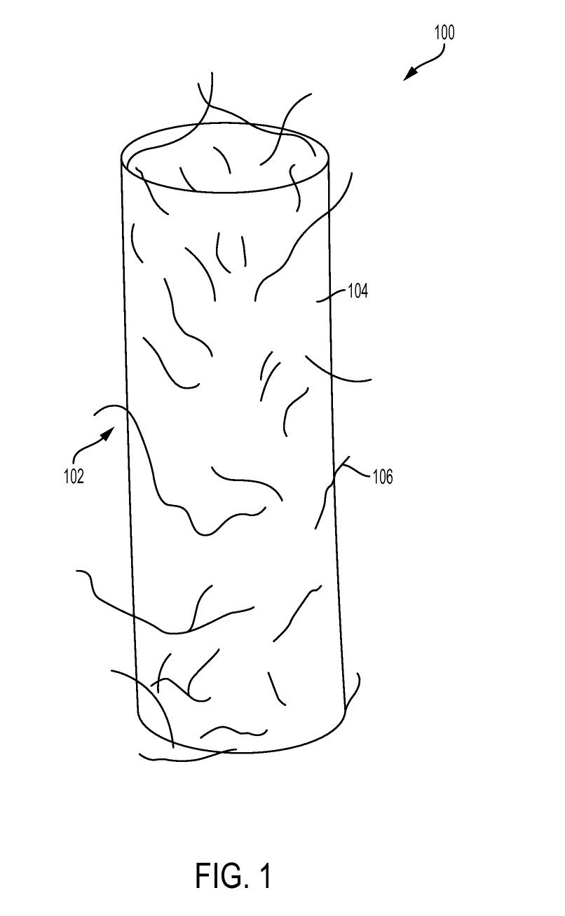

FIG. 1 shows a fertilizing and water retaining pellet 100 for use in horticultural practices according to an embodiment of the present disclosure. The pellet 100 (referred to herein as “pellet” or “pellets”) may include wool 102 from mammals. In some embodiments, the pellet 100 may include sheep wool 102. In some embodiments, the sheep wool 102 may include belly wool 102 (i.e., wool 102 from the belly area of a sheep). In other embodiments, the sheep wool 102 may comprise wool 102 taken from any location on the sheep's body. In other embodiments, the pellet 100 may include wool 102 from one or more of a sheep, goat, lama, or camel. In some embodiments, the pellet 100 may include wool 102 that is hypoallergenic.

The wool 102 included in the pellets 100 may be natural, unprocessed wool 102. For example, the wool 102 may include virgin wool 102, as understood by those skilled in the art. As used herein, the phrase “virgin wool” may refer to wool 102 that has been spun for the first time. In other words, the phrase “virgin wool” does not refer to shoddy or recycled wool 102, which is made by cutting or tearing apart existing wool 102 fabric and re-spinning the resulting fibers 106. Furthermore, the wool 102 may not be chemically treated after removing the wool 102 from an animal and prior to forming the wool 102 into pellets 100. For example, the wool 102 may not be treated with solvents, stripping agents, or detergents. As a result, the wool 102 included in the pellets 100 may retain its natural lanolin (e.g., wool wax or wool grease). In other words, lanolin may not be removed from the wool 102 (i.e., lanolin in the wool 102 may be maintained). As described in further detail below, the lanolin in the wool 102 may provide a natural lubrication and/or binder when the wool 102 is pelletized. Furthermore, keeping the lanolin in the wool 102 may provide the pellets 100 with antibacterial and anti-fungal properties. As a result, the pellet 100 may be mildew resistant and may help to prevent diseases in plants where the pellet 100 is used as a fertilizer. In addition, the lack of treatment with solvents, stripping agents, or detergents may qualify the pellets 100 including the untreated wool 102 as organic.

In some embodiments, the pellets 100 may include a binding agent 104 for binding fibers 106 of the wool 102 together and to help the pellets 100 retain a pelletized form. The binding agent 104 may include one or more of sawdust, grain, coir (i.e., natural fiber from husk of a coconut), blood meal, animal or poultry manures, or any other known natural binding agents. In some embodiments, the pellets 100 may not include a binding agent 104, and the pellets 100 may be at least substantially entirely made from wool 102. When the pellets 100 are made of at least substantially entirely wool 102, the fibers 106 of the wool 102 of the pellets 100 may naturally bind together through mechanical interference (e.g., tangling) of the fibers 106 of the wool 102 and due to natural binding agents 104 of the wool 102, such as lanolin. Furthermore, the fibers 106 of the wool 102 of the pellets 100 may naturally bind together due to compression that is experienced by the wool 102 during pelletizing processes.

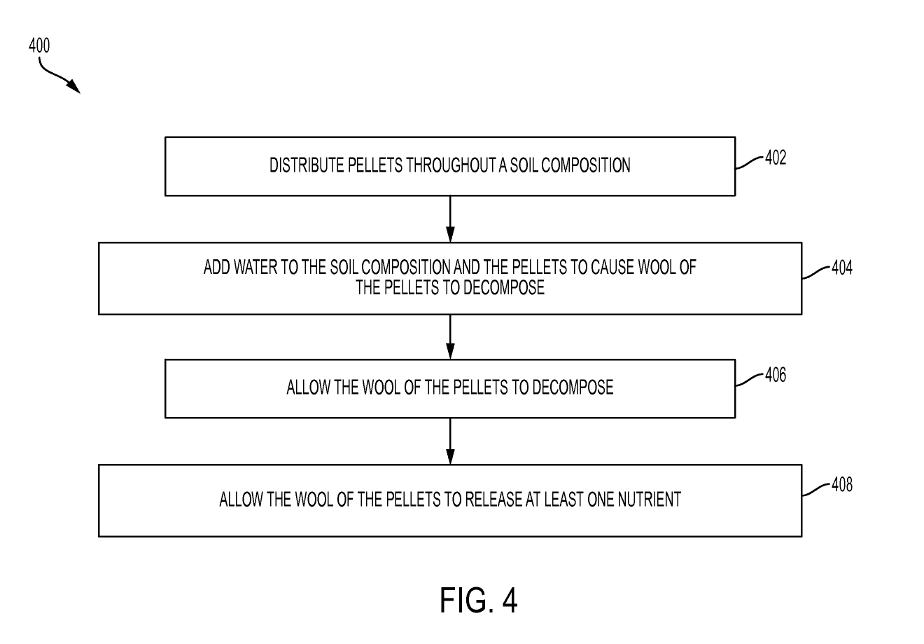

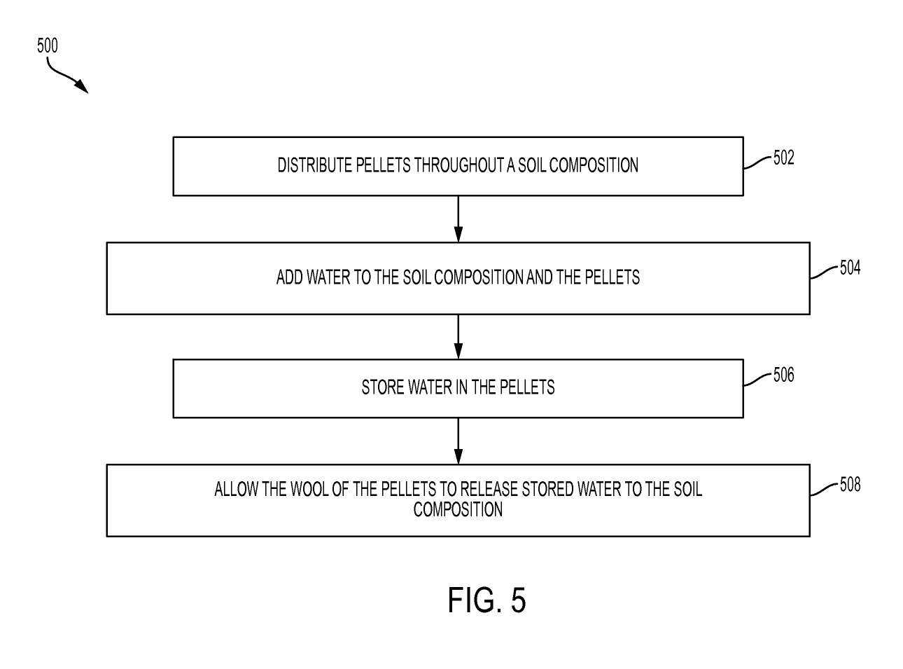

By way of example and not limitation, individual fibers 106 of the wool 102 of the pellets 100 may have a length within a range of about 1.5 cm to about 17 cm. In other embodiments, the length of the fibers 106 of the wool 102 may be within a range of about 2.5 cm to about 15 cm. In yet other embodiments, the length of the fibers 106 of the wool 102 may be within a range of about 5.0 cm to about 10 cm. Fibers 106 exhibiting the above-listed lengths may provide advantages over shortened fibers, such as fibers obtained from shoddy or scrap wool. For example, longer fibers 106 of the wool 102 may have an increased surface area of each individual fiber 106 and may exhibit a larger interface between the wool 102 and a surrounding soil composition, compared to relatively shorter fibers 106 (such as those obtained from shoddy or scrap wool). Enlarging an interface between the wool 102 and the surrounding soil composition may allow the pellets 100 to more easily release nutrients to the surrounding soil composition, as described in further detail below in regard to FIGS. 4 and 5. Enlarging an interface between the wool 102 and the surrounding soil composition may allow the pellets 100 to increase aeration to the surrounding soil composition. Moreover, longer fibers 106 of the wool 102 may improve binding of the fibers 106 of the wool 102 together during a pelletizing process used to form the pellets 100.

The wool 102 of the pellets 100 may include natural nitrogen. In some embodiments, the wool 102 of the pellet 100 may include about 8% to about 15% nitrogen by weight or volume. In some embodiments, the wool 102 of the pellets 100 may include about 10% to about 12% nitrogen by weight or volume. Furthermore, the wool 102 of the pellets 100 may include natural potassium from the wool 102. In some embodiments, the wool 102 of the pellets 100 may include about 1.0% to about 4.0% potassium by weight. In some embodiments, the wool 102 of the pellets 100 may include about 2.0% to about 3.0% potassium by weight. For example, the wool 102 of the pellets 100 may include at least about 2.86% potassium by weight. In some embodiments, the wool 102 of the pellets 100 may include about 0.0025% to about 0.0100% magnesium by weight. In some embodiments, the wool 102 of the pellets 100 may include about 0.0075% to about 0.0300% calcium by weight. In some embodiments, the wool 102 of the pellets 100 may include about 0.0025% to about 0.0035% phosphorus by weight. Furthermore, the wool 102 of the pellets 100 may include one or more of sodium, sulfur, aluminum, barium, carbon, cobalt, copper, iron, manganese, molybdenum, strontium, titanium, and zinc.

In some embodiments, the pellet 100 may have a generally cylindrical shape. In some embodiments, the pellet 100 may have a diameter with a range of about 2.0 mm to about 15 mm, within a range of about 3.0 mm to about 10 mm or within a range of about 5.0 mm to about 8.0 mm. Furthermore, the pellet 100 may have a length within a range of about 3.0 mm to about 25 mm, within a range of about 5.0 mm to about 20 mm, or within a range of about 10 mm to about 15 mm. Although the shape of the pellet 100 is shown in FIG. 1 as generally cylindrical, it is understood that the pellet 100 may have any geometric shape including, for example, a cuboid, ovoid, disc, sphere, etc. Furthermore, although the wool 102 is described herein as being in the form of a pellet 100, the disclosure is not so limited. The wool 102 may be in the form of a plug, capsule, stake, bar, ring, etc. For example, the pellet 100 may be in the form of a stake configured to be driven into soil proximate one or more plants, such as trees, shrubs, bushes, etc. The stake may have an outer diameter within a range of about 1.5 cm to about 6 cm and a length within a range of about 2.5 cm to about 30 cm. The stake may have a generally pointed end to facilitate driving the stake into soil.

In some embodiments, the pellet 100 may include other natural nutrient supplements added to the wool 102. In other words, other natural nutrients may be added to the wool 102 and binding agent 104 so that the resulting pellets 100 are configured to provide the other natural nutrients to plants. For example, the pellet 100 may include nutrient supplements comprising one or more of the following natural supplements: nitrogen, potassium, calcium, phosphorus, sodium, magnesium, sulfur, aluminum, barium, carbon, cobalt, copper, iron, manganese, molybdenum, strontium, titanium, and zinc. As described below in further detail in regard to FIG. 4, adding natural nutrient supplements to the pellets 100 may enable the pellet 100 to provide nutrients in a more uniform manner throughout a given length of time, compared to pellets 100 lacking added natural nutrient supplements. For example, a nutrient supplement included in the pellet 100 may provide the given nutrient initially while the wool 102 of the pellets 100 is decomposing. After the nutrient supplement is at least partially depleted, the wool 102 of the pellets 100 may be sufficiently decomposed to continue providing the given nutrient.

The pellet 100 may have a shelf life of at least two years in cool, dry conditions. In other words, the pellet 100 may be capable of storage for at least two years without significantly compromising qualities (e.g., nutrient concentrations, properties, form, etc.) of the pellet 100.

In some embodiments, the pellets 100 may lack any component that would compromise an ability to use the pellets 100 to grow plants organically according to the USDA organic regulations, as discussed above. In other words, every component of the pellets 100 may qualify for use to grow plants organically per the USDA organic regulations.

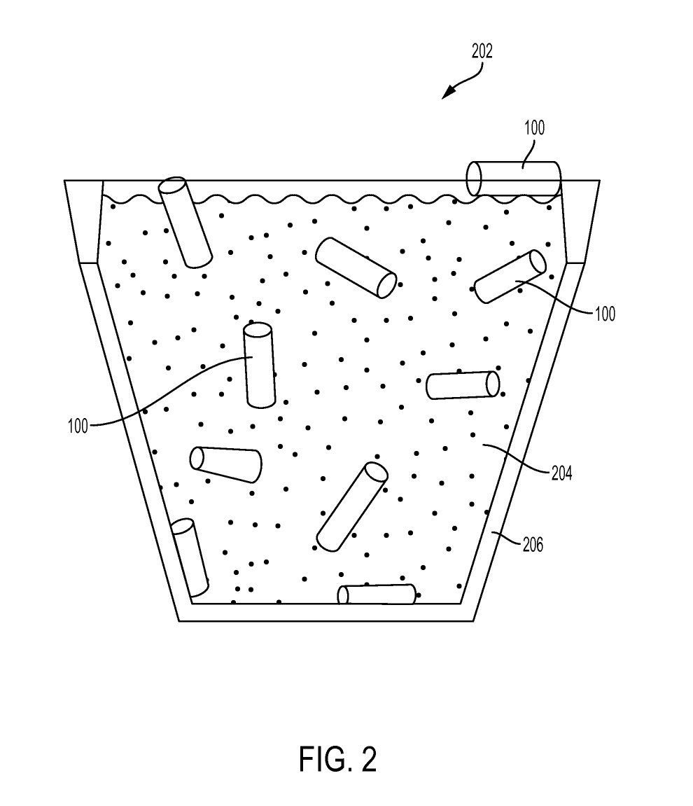

FIG. 2 shows a soil composition 202 including pellets 100 as described in regard to FIG. 1 according to an embodiment of the present disclosure. The soil composition 202 may include a growing media 204 and a plurality of pellets 100 distributed throughout the growing media 204. The plurality of pellets 100 may be distributed at least substantially uniformly throughout the growing media 204. As used herein, the term “uniform” and any derivative terms means at least substantially evenly. In other words, concentrations of pellets 100 may not differ substantially from one portion of the soil composition 202 to another. For example, when the soil composition 202 is disposed within a planting pot 206, as shown in FIG. 2, the plurality of pellets 100 may be distributed from a top of the soil composition 202 within the planting pot 206 to a bottom of the soil composition 202 within the planting pot 206. Furthermore, the plurality of pellets 100 may be distributed from a first side of the soil composition 202 within the planting pot 206 to a second, opposite side of the soil composition 202 within the planting pot 206.

In some embodiments, the soil composition 202 may include a percentage of pellets 100 within a range of about 1% to about 30% pellets 100 by volume. In other embodiments, the soil composition 202 may include about 31% to about 50% pellets 100 by volume. In other embodiments, the soil composition 202 may include about 51% to about 75% pellets 100 by volume. In other embodiments, the soil composition 202 may include about 76% to about 90% pellets 100 by volume. The growing media 204 of the soil composition 202 may include one or more of soil, sand, peat, perlite, coir, wood, wheat straw, composted bark, biodigester remains, uncomposted bark, and animal or poultry manures. The plurality of pellets 100 may be distributed throughout the growing media 204 by any number of conventional greenhouse or commercial soil mixing systems. For example, the plurality of pellets 100 may be distributed throughout the growing media 204 through barrel or drum mixing system, inline continuous mixing systems, or mechanized or non-mechanized bulk mixing, etc.

When using the soil composition 202 for planting in the ground instead of in a planting pot 206, the pellets 100 of the soil composition 202 may be distributed throughout at least a portion of an anticipated root structure of the plant. For example, the pellets 100 in the soil composition 202 may be distributed from a top surface of the ground to at least 12 cm below the top surface of the ground, such as by tilling the pellets 100 into the ground. In some embodiments, the pellets 100 in the soil composition 202 may be distributed from a top surface of the ground to at least 24 cm below the top surface of the ground. In some embodiments, the pellets 100 in the soil composition 202 may be distributed from a top surface of the ground to at least 48 cm below the top surface of the ground. In some embodiments, the pellets 100 in the soil composition 202 may be distributed from a top surface of the ground to at least 75 cm below the top surface of the ground.

The soil composition 202 may be used in root zones of plants. The pellets 100 in the soil composition 202 may improve soil porosity (i.e., air or void space between soil particles) in comparison to other known soil compositions. Improving soil porosity may, in turn, improve water distribution and nutrient retention properties of the soil composition 202 beneath a top surface of the soil composition 202. In other words, improving soil porosity may improve water distribution and nutrient retention properties of the soil composition 202 in the root zones of the plants. Moreover, the pellets 100 in the soil composition 202 may help to protect the soil composition 202, and as a result, any plants growing the soil composition 202, from toxins and other injurious substances. For example, physical characteristics of the wool 102 (e.g., elasticity of the wool 102) of the pellets 100 in the soil composition 202 may help to protect the soil composition 202 from ferrous oxide, H₂S gas, and CO₂. Additionally, physical characteristics of the wool 102 of the pellets 100 in the soil composition 202 may promote biological and microbial activities such as, for example, nitrification (i.e., biological oxidation of ammonia or ammonium to nitrite and the oxidation of nitrite to nitrate) and sulfur oxidation.

Some embodiments of the present disclosure include bagged mixes of the soil composition 202 as described above. For example, some embodiments of the present disclosure include a bagged mix of a soil composition 202, the soil composition 202 including a growing media 204 and a plurality of pellets 100 distributed at least substantially uniformly throughout the growing media 204.

In some embodiments, the soil composition 202 and pellets 100 may lack any components that would compromise an ability to use the soil composition 202 and pellets 100 to grow plants organically according to the USDA organic regulations, as discussed above. In other words, everything included in the soil composition 202 and pellets 100 may qualify for use to grow plants organically per the USDA organic regulations.

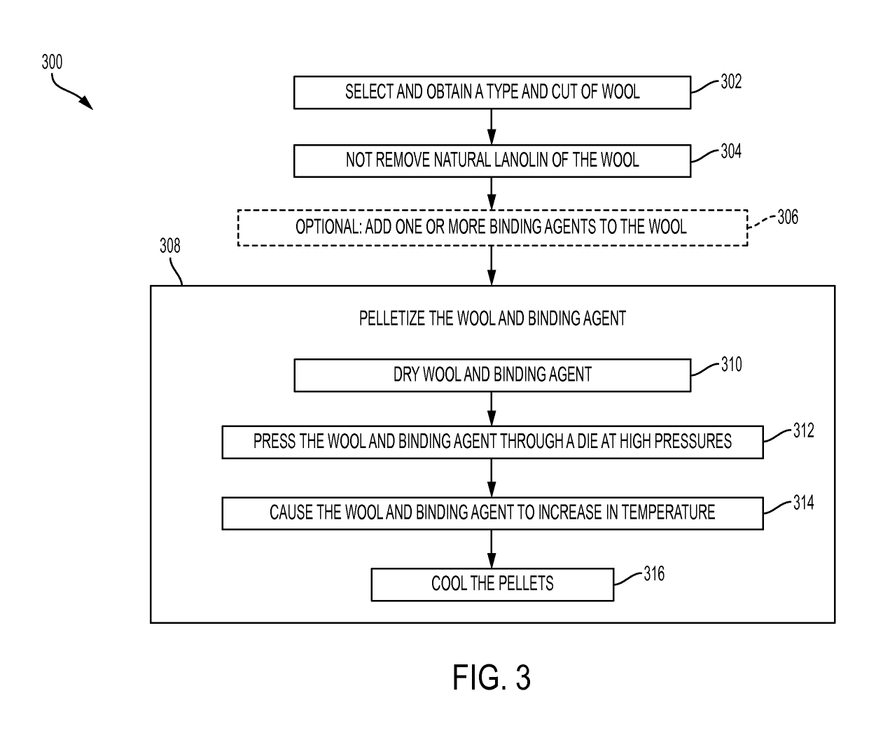

FIG. 3 shows a flowchart of a process 300 of making wool pellets according to an embodiment of the present disclosure. Referring to FIGS. 1, 2, and 3, the process 300 may include selecting a type and cut of wool 102 to be used in the pellets 100, as represented in act 302. Selecting a type and cut of wool 102 to be used in the pellets 100 may include selecting sheep wool. In some embodiments, the sheep wool may come from a belly area of the sheep. In other embodiments, the sheep wool may come from any area of the sheep's body. In some embodiments, the wool 102 may include wool 102 from one or more of a sheep, goat, lama, and camel. In some embodiments, the wool 102 may include virgin wool and may not include shoddy or recycled wool 102. Because the wool 102 may include virgin wool from sheep and is not dependent on shoddy or recycled wool, the wool 102 may be more readily available to make the pellets 100 and may retain its untreated, natural qualities.

In some embodiments, natural lanolin of the wool 102 may not be removed, as represented in act 304. In other words, the wool 102 may not be processed to remove lanolin from the wool 102. Furthermore, the wool 102 may not be treated with solvents, stripping agents, or detergents that might remove the lanolin from the wool 102. In some embodiments, the wool 102, once removed from the sheep, may not be modified, conditioned, or chemically treated prior to forming pellets 100 with the wool 102. As a result, water repelling features of the wool 102 may be retained. Furthermore, the wool 102 may not be treated in any way that might compromise an ability to use the wool 102 to grow plants organically according to the USDA organic regulations, as discussed above. In other words, any and all treatments performed on the wool 102 may not disqualify the pellets 100 including the wool 102 from use in growing plants organically per the USDA organic regulations.

In some embodiments, one or more binding agents 104 may be added to the wool 102, as represent in act 306. In some embodiments, adding the one or more binding agents 104 to the wool 102 may include adding one or more of sawdust, grain, coir, blood meal, and animal or poultry manure, or any other known natural binding agents to the wool 102. In other embodiments, no binding agent 104 may be added to the wool 102. To facilitate description of the process 300 of making the pellets 100, the following process is described using both wool 102 and a binding agent 104. However, it is understood that including a binding agent 104 is optional, and that the process may be completed without including a binding agent 104.

In some embodiments, when a binding agent 104 is added to the wool 102, the binding agent 104 may be selected for inclusion in the pellets 100 to avoid compromising an ability to use the pellets 100 to grow plants organically according to the USDA organic regulations, as discussed above. In other words, any binding agent 104 included in the pellets 100 may qualify for use to grow plants organically per the USDA organic regulations.

The process 300 may also include pelletizing the wool 102, as represented in act 308. Pelletizing the wool 102 may include drying the wool 102, as represented in act 310. For example, in some pelletizing procedures that may be applicable to the present disclosure, a moisture level should be substantially consistent throughout a material to be pelletized in order to facilitate binding and extrusion of the material. In some cases, the wool 102 and binding agents 104, prior to their incorporation into the pellets 100, may have an inconsistent moisture level throughout the wool 102 and binding agents 104. As a result, drying the wool 102 and binding agents 104 may promote a consistent moisture level throughout the wool 102 and binding agents 104. In other embodiments, the wool 102 and binding agent 104 may be dried to have at least substantially no moisture. In some embodiments, dryer drums may be used to dry the wool 102 and binding agents 104.

In some embodiments, the pellets 100 may be formed using a flat die pellet 100 mill. For example, pelletizing the wool 102 may include pressing the wool 102 and binding agent 104 through one or more dies, as represented in act 312. Furthermore, the wool 102 and binding agent 104 may be pelletized through extrusion using an extruder. Pressing the wool 102 and binding agent 104 through one or more dies may cause the wool 102 and binding agent 104 to increase in temperature, as represented in act 314. Causing the wool 102 and binding agent 104 to increase in temperature may cause the wool 102 and/or binding agent 104 to release lanolin or other substances that may bind the fibers 106 of wool 102 and the binding agent 104 together. For example, in embodiments where sawdust is used as a binding agent 104, causing the sawdust to heat up may release natural lignins in the wood of the sawdust to bind the wool 102 and the sawdust together. The lanolin of the wool 102 may also act as a natural lubrication in the extrusion process.

In some embodiments, the wool 102 and binding agent 104 may reach temperatures between about 90° C. and about 250° C. during the extrusion process. In other embodiments, the wool 102 and binding agent 104 may reach temperatures between about 90° C. and about 150° C. In other embodiments, the wool 102 and binding agent 104 may reach temperatures between about 90° C. and about 125° C. Causing the wool 102 and binding agent 104 to reach such temperatures may help to control a bacteria level in the wool 102 and binding agent 104. For example, the temperature of the wool 102 and binding agent 104 may be allowed to rise to a level sufficient to kill at least substantially all the bacteria in the wool 102 and binding agent 104. Furthermore, causing the wool 102 and binding agent 104 to increase in temperature may control a bacteria level in the wool 102 and binding agent 104 without using a bactericide, such as a bactericide that would otherwise disqualify the pellets 100 from use to grow plants according to USDA organic regulations.

The pellets 100 may exit the extruder at temperatures between about 90° C. and about 250° C. Furthermore, when the pellets 100 exit the extruder, the pellets 100 may be soft. The hot and soft pellets 100 may be allowed to cool, such as in a cooling tower, as represented act 316. As the pellets 100 cool, the pellets 100 may harden. As discussed above, after the pellets 100 have cooled, the pellets 100 may be stored for up to two years without compromising qualities of the pellets 100 while the pellets 100 await bagging, bulk distribution, or use. In some embodiments, during the pelletizing process, no steps may be taken that may compromise an ability to use the pellets 100 to grow plants organically according to the USDA organic regulations, as discussed above.

Some embodiments of the present disclosure include methods of providing substances to a plant (e.g., to roots of a plant). FIG. 4 shows a flowchart of a process 400 of providing nutrients to a plant. Referring to FIGS. 1, 2, and 4 together, the process 400 may include distributing pellets 100 throughout a soil composition 202 in which a plant is to be planted or is already planted, as represented in act 402. For example, the pellets 100 may be distributed throughout a soil composition 202 in a planting pot 206 or in ground. The pellets 100 may include pellets 100 as described in regard to FIG. 1. Furthermore, the pellets 100 may be distributed to have a substantially uniform concentration and distribution within the soil composition 202, as described above in regard to FIG. 2.

The process 400 may include adding water to the soil composition 202 and to the pellets 100 to cause wool 102 of the pellets 100 to decompose, as represented in act 404. As used herein, the term “decompose” may mean to decay or to break down into simpler constituents (e.g., elements, materials, etc.). The wool 102 of the pellets 100 may be allowed to decompose in the soil composition 202, as represented in act 406. In some embodiments, water may be recurrently added to the soil composition 202 and the pellets 100 until and after the pellets 100 substantially fully decompose.

When the wool 102 of the pellets 100 begins to decompose, the wool 102 of the pellets 100 may release at least one nutrient into the surrounding soil composition 202, as represented in act 408. In some embodiments, the pellets 100 may release nitrogen into the surrounding soil composition 202, and as a result, may provide nitrogen to a plant (e.g., roots of a plant) growing in the soil composition 202. Providing nitrogen to plants helps plant foliage to develop faster and stronger. In some embodiments, the pellets 100 may release Potassium into the surrounding soil composition 202, and as a result, may provide Potassium to a plant growing in the soil composition 202. Providing potassium to plants helps in root development, water absorption of the plants, reduces disease in plants, and helps to prevent heat damage to plants. In some embodiments, the pellets 100 may release one or more of calcium, phosphorus, sodium, magnesium, sulfur, aluminum, barium, carbon, cobalt, copper, Iron, manganese, molybdenum, strontium, titanium, and zinc into the surrounding soil composition 202.

Because the nutrients are released while the pellets 100 decompose, the pellets 100 may provide a slow but continuous release of the nutrients over a given timeline. For example, depending on frequencies of providing water to the pellets 100 and temperatures of the soil, the pellets may provide nutrients to the plants for periods between four weeks and twelve months. In some embodiments, the wool 102 of the pellets 100 may take at least about two weeks to decompose sufficiently to begin to provide significant nutrients to plants. In other embodiments, the wool 102 of the pellets 100 may take at least about four weeks to decompose sufficiently to begin to provide significant nutrients to plants. In yet other embodiments, the wool 102 of the pellets 100 may take at least about six weeks to decompose sufficiently to begin to provide significant nutrients to plants.

In some embodiments, as described above, the pellets 100 may include at least one nutrient supplement added to the wool 102, wherein the nutrient supplement provides a given nutrient while the pellet 100 is beginning to decompose (e.g., a quick-acting natural fertilizer). As a non-limiting example, the pellets 100 may have a nitrogen supplement added to the wool 102, and the nitrogen supplement may provide nitrogen to a plant for a first two weeks of use while the pellets 100 begin to decompose. After two weeks, the nitrogen supplement may become depleted and the pellets 100, now partially decomposed, may begin to provide nitrogen to the plant. In some embodiments, the nutrient supplements added to the pellets 100 may be tailored (e.g., an amount added to the pellets 100 may be tailored) such that the nutrient supplements will deplete at least about a same time as the pellets 100 begin to provide the nutrients. In some embodiments, nutrient supplements containing one or more of nitrogen, potassium, calcium, phosphorus, sodium, magnesium, sulfur, aluminum, barium, carbon, cobalt, copper, Iron, manganese, molybdenum, strontium, titanium, and zinc may be added to the pellets 100. In other embodiments, the pellets 100 may not include a nutrient supplement. In such embodiments, the pellets 100 of the soil composition 202 may be allowed to decompose for a time sufficient to begin releasing nutrients before a plant is disposed within the soil composition.

Because the pellets 100 are distributed at least substantially uniformly through the soil composition 202, the pellets 100 may provide an at least substantially uniform distribution of the nutrients throughout the soil composition 202. Accordingly, the pellets 100 may provide advantages over other known fertilizing methods by uniformly providing nutrients to roots of plants (e.g., to at least substantially all locations of the roots of the plants within the soil composition 202). Furthermore, because the nutrients are released as the pellets 100 decompose, once the pellets 100 sufficiently decompose, the pellets 100 may deliver the nutrients in an at least substantially uniform manner over a period of time. In other words, over a given amount of time, the pellets 100 may deliver the nutrients at an at least substantially constant rate over that time period. For example, over a week's time, the pellets 100 may deliver at least substantially a same amount of nutrients each day of the week.

Because the pellets 100 are distributed at least substantially uniformly through the soil composition 202, the pellets 100 may promote an at least substantially uniform aeration throughout the soil composition 202. Accordingly, the pellets 100 may provide advantages over other know fertilizing methods by at least substantially uniformly providing aeration to roots of plants.

Furthermore, as discussed above, the pellets 100 may be mildew resistant due to mildew resistant properties of the wool 102. As a result, the soil compositions 202 including the pellets 100 may help to keep plants healthy even when the plants are overwatered. Furthermore, the pellets 100 may act as a natural pesticide for pests such as slugs and snails. Accordingly, the soil compositions 202 including pellets 100 may be resistant to infestations of slugs and snails.

In tests performed by the inventors, using the pellets 100 to provide nutrients to the plants showed significant increases in size of the plants and the number of blooms of the plant when compared to traditional greenhouse soil mixes having common fertilizers. The tests were performed over a twelve-week period. A first test group included plants planted in a soil composition 202 having by volume 90% peat and 10% wool pellets 100 as described in regard to FIG. 1. A second test group included plants planted in a soil composition 202 having by volume 95% peat and 5% wool pellets 100. A third test group included plants planted in a soil composition having by volume 70% peat and 30% perlite, which is considered a traditional greenhouse soil mix. A fourth test group included plants planted in a soil composition having by volume 70% peat and 30% wood chips. For the first six weeks, all test groups were watered with a greenhouse water including a balance nutrient fertilizer having 120 PPM nitrogen. For the second 6 weeks each group was watered with clear water and no additional fertilizers were added to the soil compositions. The average greenhouse temperature for the trial was about 20° C.

After the twelve-week period, in comparison to the plants of the fourth test group, the plants in the first test group (wool 10%) were 2.0 to 3.0 times bigger in size and had 3.0 to 4.0 times more blooms. In comparison to the plants of the third test group, the plants in the first test group (wool 10%) were 1.5 to 2.0 times bigger in size and had 1.5 to 2.0 times more blooms. Furthermore, in comparison to the plants of the fourth test group, the plants in the second test group (wool 5%) were 1.5 to 2.0 times bigger in size and had 2.0 to 3.0 times more blooms. In comparison to the plants of the third test group, the plants in the second test group (wool 5%) were 1.25 to 1.75 times bigger in size and had 1.5 to 2.0 times more blooms. Accordingly, as demonstrated by the results of the above tests, using wool pellets 100 in soil compositions to grow plants provides better results (e.g., size and health of plants) when compared to traditional greenhouse fertilizers while, at the same time, growing the plants organically.

In some embodiments, when using the pellets 100 to provide nutrients to plants, no steps may be taken that may compromise an ability to use the pellets 100 to grow plants organically according to the USDA organic regulations, as discussed above. In other words, every step taken while using the pellets 100 to provide nutrients to plants may qualify as growing plants organically per the USDA organic regulations.

FIG. 5 shows a flowchart of a process 500 of providing water to a plant. Referring to FIGS. 1, 2, and 5 together, the process 500 may include distributing pellets 100 throughout a soil composition 202 in which a plant is to be planted or is already planted, as represented in act 502. For example, the pellets 100 may be distributed throughout a soil composition 202 in a planting pot 206. The pellets 100 may include pellets 100 as described in regard to FIG. 1. Furthermore, the pellets 100 may be distributed to have a substantially uniform distribution within the soil composition 202 as described in regard to FIG. 2.

The process 500 may include adding water to the soil composition 202 and to the pellets 100, as represented in act 504. Furthermore, the process 500 may include storing water in the pellets 100 in the soil composition 202, as represented in act 506. For example, water may be stored in the wool 102 of the pellets 100 due to the ability of the wool 102 to absorb and retain water. Storing water in pellets 100 may include adding water to the soil composition 202 and pellets 100 until the pellets 100 hold (e.g., retain) a desired amount of water. In some embodiments, the pellets 100 may reach saturation (e.g., a maximum amount of water that can be absorbed) within 15 minutes of being continuously exposed to water.

In some embodiments, the pellets 100 may have a maximum capacity to hold water (e.g., an amount of water the pellets 100 are capable of absorbing and retaining). In some embodiments, the pellets 100 may have a capacity to hold an amount of water of at least about 5 times a dry weight of the pellets 100. In some embodiments, the pellets 100 may have a capacity to hold an amount of water of at least about 10 times a dry weight of the pellets 100. In some embodiments, the pellets 100 may have a capacity to hold an amount of water of at least about 15 times a dry weight of the pellets 100. In some embodiments, the pellets 100 may have a capacity to hold an amount of water of at least about 20 times a dry weight of the pellets 100. As a result, soil compositions 202 having pellets 100 distributed throughout the soil compositions 202 may have increased capacities to hold water in comparison to traditional greenhouse soil mixes.

The process 500 may further include allowing the pellets 100 to release water stored in the pellets 100 to the soil composition 202, as represented in act 508. Allowing the pellets 100 to release the water stored in the pellets 100 to the soil composition 202 may provide water to plants that are growing in the soil composition 202.

In tests performed by the inventors, using pellets 100 to retain water in soil compositions 202 and to provide water to plants showed that, over a six-day period, soil compositions having pellets 100 distributed throughout the soil compositions retained more water than traditional greenhouse soil mixes. The tests included a first test group (“Group 1”) having a soil composition 202 comprising 90% peat and 10% pellets 100 and a second test group (“Group 2”) having a soil composition comprising 70% peat and 30% perlite, a traditional greenhouse soil mix. Each test group included a 7.57-liter (2.0-gallon) basket wherein the soil compositions were disposed. Each test group was watered to saturation and not watered again for the next six days. The average temperature during the trial was 22° C. The results of the tests are shown in the below table.

| | Pre-watering | Weight | Weight | Weight | Weight | Weight | Weight |
|---|---|---|---|---|---|---|---|
| | weight | (kg) at | (kg) at | (kg) at | (kg) at | (kg) at | (kg) at |
| Group | (kg) | 1 Day | 2 Days | 3 Days | 4 Days | 5 Days | 6 days |
| Group 1 | 2.43 | 5.00 | 4.85 | 4.66 | 4.47 | 4.24 | 3.86 |
| Group 2 | 2.39 | 3.76 | 3.51 | 3.18 | 3.03 | 2.92 | 2.74 |

Accordingly, at the end of the six-day period, Group 2 had 0.35 kg of water remaining in the soil composition 202, and Group 1 had 1.43 kg of water in the soil composition 202. Put another way, Group 1 absorbed and retained over four times as much water as Group 2 over the six-day period. Furthermore, Group 1 retained over 50% of the water originally added to Group 1 over the 6-day period. In comparison, Group 2 retained only 25% of the water originally added to Group 2 over the six-day period. Significantly, the amount of water that was retained in the soil of Group 1 after six days (1.43 kg) was slightly more than the amount of water that was retained in the soil of Group 2 after only one day (1.37 kg).

By absorbing and retaining more water than traditional greenhouse soil mixes, a soil composition 202 containing the pellets 100 may provide advantages in providing water to plants. For example, the pellets 100 may provide a more constant source of water to plants. In other words, by absorbing and retaining more water, the pellets 100 may provide a more consistent amount of water to plants over time. Providing a more consistent and constant source of water may promote plant growth and development, and may produce higher quality plants, which, in turn, may increase profits for growing the plants. Furthermore, growing plants in soil compositions including the pellets 100 may require less watering than growing plants in traditional greenhouse soil mixes. Moreover, there may be longer periods of time between each watering of the plants. Accordingly, water costs and labor costs may be reduced in caring for plants that are grown in soil compositions 202 including the pellets 100. Likewise, soil compositions 202 including the pellets 100 may lead to less plant losses or damage due to missed waterings or the soil drying out. Additionally, soil compositions 202 including the pellets 100 may enable plants to grow in more arid environments than enabled by traditional greenhouse soil mixes.

Furthermore, by absorbing and retaining water, the pellets 100 may help to reduce nutrient leaching (i.e., losing water-soluble plant nutrients from soil due to rain and irrigation). By absorbing and retaining water, the pellets 100 may also absorb water-soluble plant nutrients and may protect the water-soluble nutrients from being washed out of the soil due to rain or irrigation. Furthermore, as the pellets 100 decompose, those water-soluble plant nutrients may be released and provided to the plants.

In some embodiments, when using the pellets 100 to provide water to plants, no steps may be taken that may compromise an ability to use the pellets 100 to grow plants organically according to the USDA organic regulations, as discussed above. In other words, every step taken while using the pellets 100 to provide water to plants may qualify as growing plants organically per the USDA organic regulations.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A pellet for fertilizing and watering plants, comprising: wool from a belly area of one or more sheep compressed in a pelletized form, the wool comprising natural lanolin.

2. The pellet of claim 1, wherein the wool comprises between about 8% and about 15% nitrogen by volume.

3. The pellet of claim 1, wherein the wool comprises between about 1.0% and about 4% potassium by volume.

4. The pellet of claim 1, wherein the wool comprises phosphorus.

5. The pellet of claim 1, wherein the wool consists essentially of wool from the belly area of one or more sheep.

6. The pellet of claim 1, further comprising a binding agent for binding fibers of the wool together into the pelletized form.

7. The pellet of claim 6, wherein the binding agent comprises sawdust and lignins of the sawdust.

8. A method of making pellets for fertilizing and watering plants, the method comprising:
selecting and obtaining a type and cut of wool from an animal;
not removing natural lanolin from the wool; and
pelletizing the wool.

9. The method of claim 8, wherein selecting and obtaining a type and cut of wool from an animal comprises selecting virgin sheep wool.

10. The method of claim 8, wherein selecting and obtaining a type and cut of wool comprises selecting and obtaining wool comprising fibers having lengths within a range of about 2.5 to about 15 cm.

11. The method of claim 8, wherein not removing natural lanolin from the wool comprises not treating the wool with solvents, stripping agents, or detergents.

12. The method of claim 8, wherein pelletizing the wool comprises:
adding a binding agent to the wool; and
pressing the wool and the binding agent through at least one die to form pellets.

13. The method of claim 12, wherein pelletizing the wool further comprises drying the wool to have an at least substantially consistent moisture content at least substantially throughout the wool.

14. The method of claim 12, wherein pelletizing the wool further comprises causing the wool and the binding agent to increase in temperature while pressing the wool and the binding agent through at least one die under pressure.

15. The method of claim 14, wherein causing the wool and the binding agent to increase in temperature comprises causing the wool and the binding agent to reach a temperature of at least about 90° C.

16. The method of claim 12, wherein pelletizing the wool further comprises cooling the pellets in a cooling tower.

17. A method of providing a substance to roots of a plant, the method comprising:
distributing pellets throughout a soil composition, the pellets comprising:
wool from a belly area of a sheep, the wool including natural lanolin; and
a binding agent;
adding water to the pellets and soil composition; and
allowing the pellets to release the substance to the soil composition and roots of the plant.

18. The method of claim 17, wherein adding water to the pellets and soil composition comprises adding water to the pellets to cause the pellets to decompose.

19. The method of claim 17, wherein the substance comprises a nutrient.

20. The method of claim 19, wherein the nutrient comprises nitrogen.

21. The method of claim 19, wherein the nutrient comprises potassium.
